(19) United States
(12) Patent Application Publication
(10) Pub. No.: US 2012/0118098 A1
(43) Pub. Date: May 17, 2012

(54) INSTRUMENT POSITIONING/HOLDING DEVICES

(76) Inventors: Mark C. Doyle, Del Mar, CA (US); Jimmy Caputo, Carlsbad, CA (US)

(21) Appl. No.: 12/521,073

(22) PCT Filed: Dec. 4, 2007
(86) PCT No.: PCT/US2007/086416

§ 371 Date: Feb. 16, 2010

Related U.S. Application Data
(60) Provisional application No. 60/872,924, filed on Dec. 5, 2006.

(51) Int. Cl. G05G 11/00

(52) U.S. Cl. 74/490.12

(57) ABSTRACT

Systems are provided that control the positioning of various instruments (e.g., endoscopes or tissue retractors) used during surgical procedures. A positioning mechanism holding the instrument is coupled to a control mechanism such that mechanical manipulation of the control mechanism results in movement of the positioning mechanism relative to a patient's body, thereby eliminating the need to manually hold and position the instruments.

### RELATED APPLICATION

This application claims the benefit of U.S. Provisional Application No. 60/872,924, filed Dec. 5, 2006, which is incorporated herein by reference in its entirety.

### FIELD OF THE INVENTION

The invention relates generally to surgical instruments. More particularly, the invention relates to devices for positioning/holding a surgical instrument and methods of positioning/holding a surgical instrument.

### BACKGROUND OF THE INVENTION

Endoscopic surgical procedures are performed using long slender surgical instruments inserted into the patient through small incisions. In order to visualize the surgical site an endoscope is also inserted into the patient through another incision. A camera is attached to the endoscope, and the image is projected onto a nearby video display, which the surgeon looks at to monitor his/her activities inside the patient.

In order to permit the surgeon to use both hands for the surgery the endoscope is held in the desired position by an assistant, a stationary adjustable arm, or a voice-controlled robotic positioning device. All three have significant drawbacks. The assistant, besides being a costly paid employee, can be difficult to communicate with, can get tired, and can lose concentration and let the endoscope position drift. The stationary adjustable arms require that the surgeon reach over to adjust them with two hands, wasting valuable time and disrupting the procedure. The voice-controlled robotic positioning devices are expensive, require significant set-up effort, and often require too much time to communicate with.

During many procedures an assistant also positions and holds a retracting instrument in order to push tissue or organs out of the way of the surgeon's instrument. The same issues of communication, concentration, and fatigue are present in this task also.

There thus remains a need in the art for a positioner/holder having at least of one of the following characteristics: simple to set-up and use, controlled directly by the user, and that securely holds an endoscope and/or other instrument (hereinafter collectively referred-to as “instrument”).

### SUMMARY OF THE INVENTION

Embodiments of the devices of the present invention provide a generally rugged and generally simple to set-up and use positioning apparatus. Such devices can be used to position and hold any appropriate instrument in the surgical field. Embodiments that are mechanical are generally rugged, require no utilities, and are easily set-up, cleaned, and sterilized.

The devices of the present invention include a control mechanism and a positioning mechanism. In some embodiments, the control mechanism and positioning mechanism are connected together by a mechanical means for transmitting force from the control handle to the positioning mechanism. In some embodiments the connection is a hydraulic system. In some embodiments, the hydraulic system is a closed-loop hydraulic system. In some embodiments the connection is a push-pull cable assembly. In some embodiments the connection is a system of cables and pulleys. In some embodiments the connection is made by two or more of a hydraulic system, a push-pull cable assembly, or a system of cables and pulleys. The control mechanism is located in a location generally convenient for the user. Movements of the control mechanism reposition the instrument because the positioning mechanism responds to the motion of the control mechanism, thereby repositioning the instrument to the desired location. In some embodiments the control mechanism is a handle. In some embodiments the control mechanism can be operated by the use of only one hand of the operator.

The devices of the present invention can have a variety of possible motion axes, or degrees of freedom, to achieve the desired control. In some embodiments, the device has two tilt axes and one extend axis. In some embodiments a first tilt axis allows the user to tilt the instrument forward or backward, thereby moving the tip of the instrument forward or backward. In some embodiments a second tilt axis tilts the tip of the instrument from side to side. The extend axis allows the user to extend or retract the tip of the instrument further in or out of the patient. In some embodiments, a rotate axis permits the user to rotate the instrument about its length. In some embodiments, the device includes additional motion axes, such as a grasp axis and a bend axis. The various axes described herein can be used in any combination in a particular embodiment.

In some embodiments, the positioning mechanism comprises a braking mechanism that can lock the positioning mechanism into a particular position, and wherein the control mechanism comprises an actuator for said braking mechanism.

In some embodiments, the positioning mechanism utilizes the tissue of the patient to create a pivot point for positioning of the instrument within the patient's body. In some embodiments, the positioning mechanism utilizes non-rigid pivot elements in positioning the instrument within the human body.

In some embodiments, the present invention includes methods of positioning an instrument for use in a surgical procedure. In some embodiments, these methods include methods of using the claimed devices to position an instrument for use during a surgical procedure. In some embodiments, the methods permit the surgeon to use only one hand to position an instrument for use during a surgical procedure.

### BRIEF DESCRIPTION OF THE DRAWINGS

The features, objects and advantages of the present invention will become more apparent from the detailed description set forth below when taken in conjunction with the drawings in which like references identify correspondingly throughout, and wherein:

FIG. 1 shows a perspective view of an embodiment of the present invention used in conjunction with various surgical devices during a surgical procedure.

FIG. 2 shows a schematic view of an embodiment of the positioning mechanism and an embodiment of the control mechanism connected by a mechanical force-transmitting connector.

FIG. 3 shows a schematic view of an embodiment of the positioning mechanism and an embodiment of the control mechanism connected by a hydraulic mechanical-force-transmission connector.

FIGS. 4a-4c show a schematic view of an embodiment of a closed-loop hydraulic system.

FIGS. 5a-f show a schematic view of the relationship between motions of an embodiment of the control mechanism and an embodiment of the positioning mechanism.

FIGS. 6a-c show a close-up schematic view of an embodiment of the positioning mechanism.

FIG. 7 shows a schematic view of an embodiment of the positioning mechanism and an embodiment of the control mechanism connected by a push-pull cable mechanical-force-transmission connector.

FIG. 8 shows a close-up schematic view of an embodiment of the control mechanism that utilizes a push-pull cable mechanical-force-transmission connector.

FIG. 9 shows a close-up schematic view of an embodiment of the positioning mechanism that utilizes a push-pull cable mechanical-force-transmission connector.

FIG. 10 shows a schematic view of an embodiment of the positioning mechanism and an embodiment of the control mechanism connected by a system of cables and pulleys.

FIGS. 11a-c show a close-up view of an embodiment of the control mechanism that has an embodiment of a brake system.

### DETAILED DESCRIPTION OF PREFERRED EMBODIMENTS

Certain embodiments of the invention will now be described with reference to the figures.

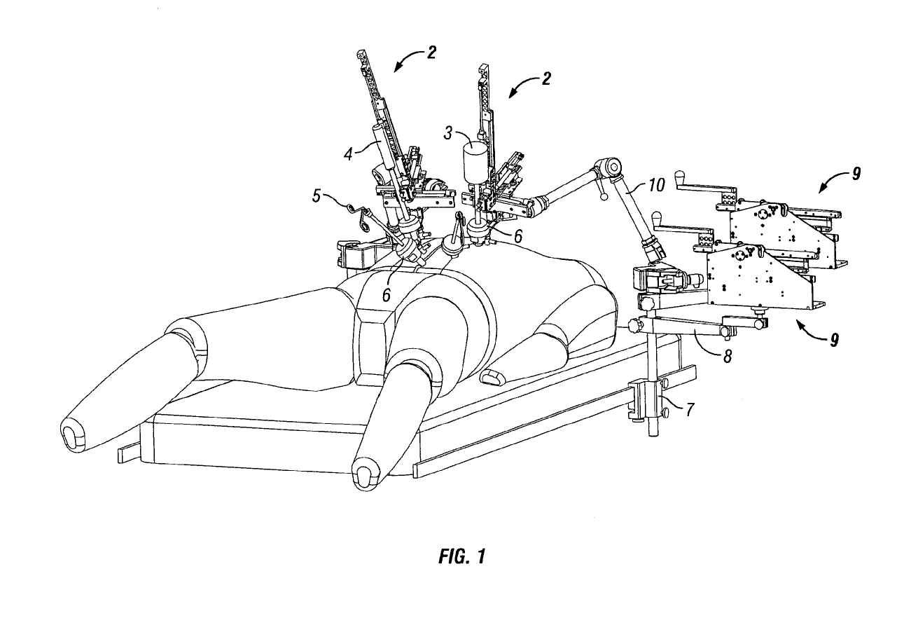

Referring to FIG. 1, numerous surgical devices are shown inserted into a patient on an operating bed. Laparoscopic instruments 5 are inserted through access ports 6 to cut, suture, manipulate tissue, etc. An endoscope/camera assembly 3, used to visualize the surgical site, is also inserted through an access port 6, and is held in place by the positioning mechanism 2. The positioning mechanism 2 is held by an adjustable arm 10, which is mounted on a support structure 7. A control handle 9 is mounted on a support bracket 8. In use, the user controls the position of the endoscope/camera 3 by manipulating the control handle 9, which causes the positioning mechanism 2 to move the endoscope/camera 3 to the desired position. Once the user stops manipulating the control handle 9 the positioning mechanism 2 stops moving and holds the endoscope/camera 3 in the new position.

Other instruments can also be positioned and held in this way. For example, a retractor 4 is shown attached to a positioning mechanism 2 in the same way as the endoscope/camera. The retractor 4 is pushed against organs or tissue to hold them out of the surgeon's way. The user manipulates the appropriate control handle 9 to cause the positioning mechanism 2 to move the retractor 4 in the appropriate direction. Once the user stops moving the control handle 9 the positioning mechanism 2 stops moving and holds the retractor 4 in the desired position. Of course any other instrument useful in a surgical procedure could be held and manipulated by embodiments of the devices of the present invention. The variety of devices which can be thus moved and held by the positioning mechanism and control handle are referred to below as “instrument(s)”. The instruments may be permanently coupled to the positioning mechanism 2 or interchangeable attached. In some embodiments, an instrument is coupled to the positioning mechanism 2 prior to the instrument's insertion into the patient's body. In other embodiments, the instrument is first manually inserted into the body and positioned followed by coupling to the positioning mechanism 2. In some embodiments, the positioning mechanism is located outside of the patient's body and couples to an instrument outside of the patient's body.

With the positioning mechanism 2 and control handle 9 arrangement described above the surgeon can reposition and hold various instruments without the need for an assistant—thereby avoiding the problems of communicating with that assistant, or the problems of fatigue and loss of attention of the assistant.

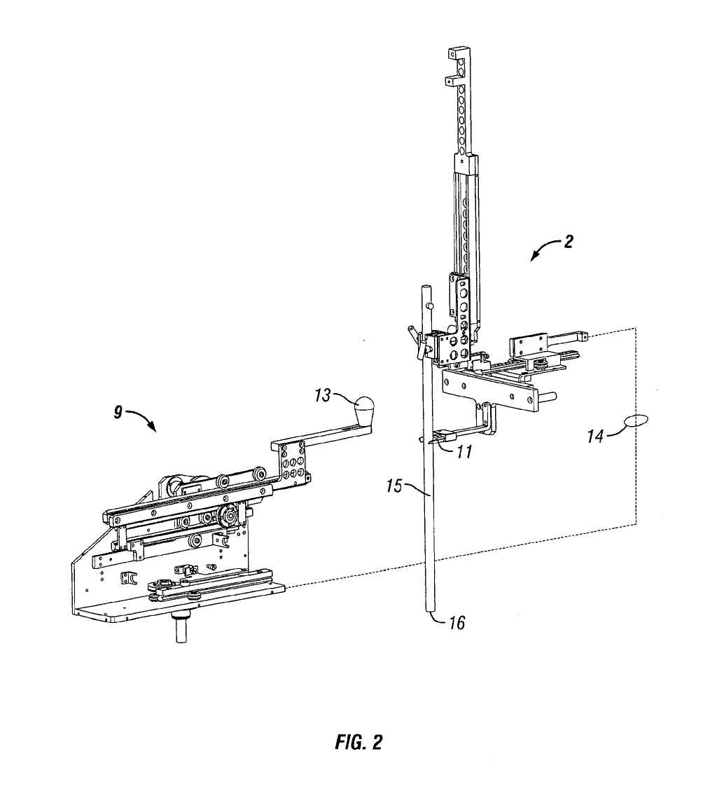

FIG. 2 shows an embodiment of the positioning mechanism 2 and an embodiment of the control mechanism, control handle 9, connected by a mechanical force-transmitting connector 14. This mechanical force-transmitting connector 14 transmits force signals from the control handle 9 to the position mechanism 2, allowing the user to move the positioning mechanism 2 by manipulating the control handle 9. As discussed below, the mechanical force-transmitting connector 14 can be hydraulic, cable-pulley, push-pull cable, or other mechanical means.

The control mechanism can have any configuration which permits the surgeon to effectively manipulate the positioning mechanism. In the depicted embodiment, the control mechanism is a particular control handle 9. However, other control mechanisms are contemplated. By way of non-limiting example, the control mechanism may have a glove-like configuration that engages the users arm, hand, and fingers.

In use, the user moves the control handle 9 by pushing knob 13 in the desired direction. Force signals are transmitted from the control handle 9 to the positioning mechanism 2 via the mechanical force-transmitting connector 14, causing the positioning mechanism 2 to move in response. The instrument 15 moves in several axes. In a preferred embodiment the instrument pivots about the point 11 where it enters the patient. The patient's tissue at point 11 can serve as the pivot, or a pivot bearing (not shown) can be provided to cause the instrument 15 to pivot about point 11. The positioning mechanism 2 pushes the instrument 15 forward-backward, side-to-side, or any combination of these two. The instrument 15, constrained at point 11 by either the patient's tissue or a pivot bearing (not shown), tilts about point 11, with the result that the distal tip of the instrument 16 moves to a new position inside of the patient. The preferred embodiment also contains an extend axis which permits the user to extend or retract the distal end of the instrument 16.

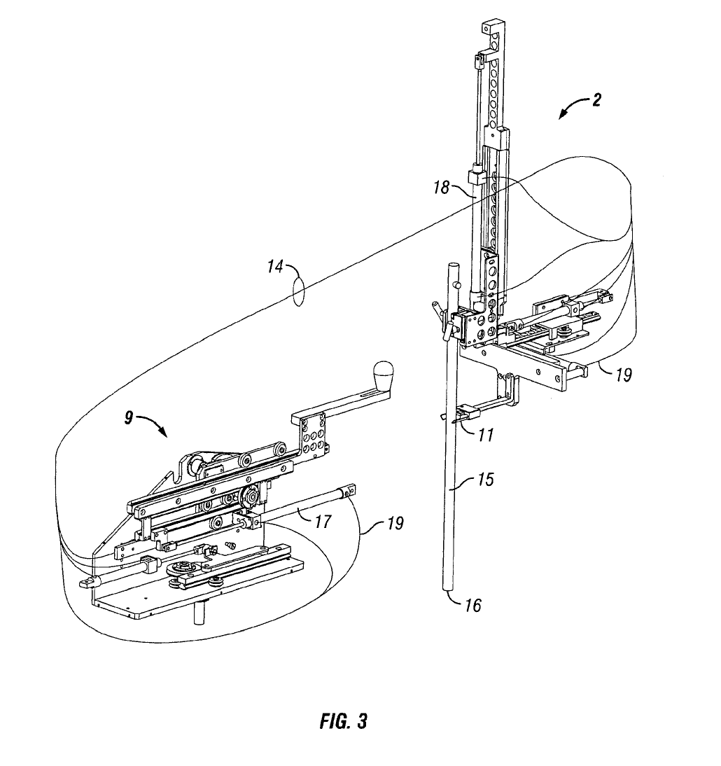

Referring to FIG. 3, a preferred embodiment is shown in which the mechanical-force-transmission connection is hydraulic. Motions of the control handle 9 cause hydraulic fluid (not shown) to travel through tubing to the positioning mechanism 2, which responds to tilt and/or extend/retract the instrument 15 about point 11, thereby repositioning the distal tip 16 of the instrument 15 inside the patient. Conventional hydraulic systems, employing cylinders, pumps, valves, and reservoirs can be used. A preferred hydraulic method is shown in FIG. 3. Control hydraulic cylinder(s) 17 in the control handle 9 are connected in a closed-loop circuit to slave hydraulic cylinder(s) 18 in the positioning mechanism 2 via tubing 19. When the user moves the control handle 9 to a new position, the shaft of the control cylinder 17 is pushed or pulled, thereby displacing hydraulic fluid in the control cylinder 17. This hydraulic fluid is forced through tubing 19 to the responding slave cylinder 18 in the positioning mechanism 2, causing the shaft of the slave cylinder 18 to move. This movement is used to tilt and/or extend/retract the instrument.

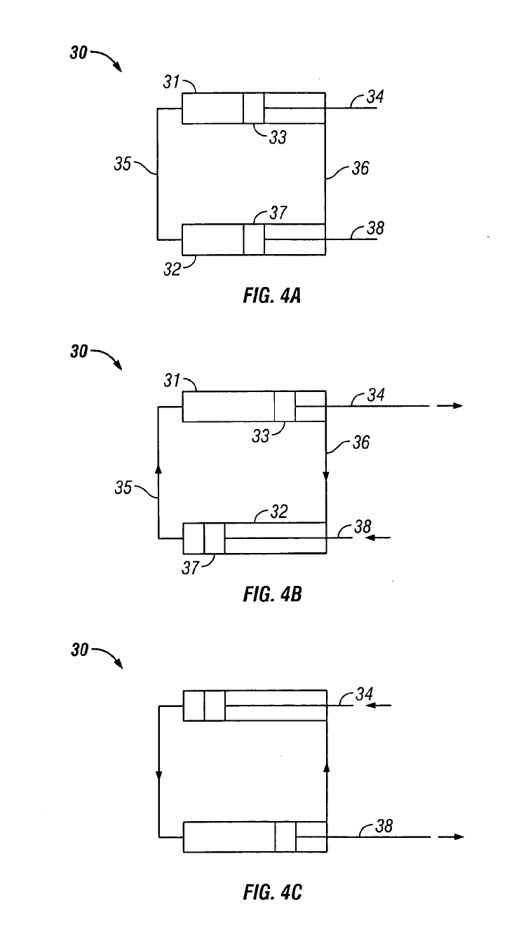

FIGS. 4a-4c. show this action in schematic form. A basic closed-loop hydraulic circuit 30 is shown in FIG. 4a. The control cylinder 31 contains a piston 33 which is connected to a shaft 34. Similarly, the slave cylinder 32 contains a piston 37 connected to a shaft 38. The back side of each cylinder is connected to the other by tubing 35. Similarly, the front side of each cylinder is connected to the front of the other by means of tubing 36.

As shown in FIG. 4b, the shaft 34 of the control cylinder 31, located in the control handle 9, is pulled to the right, pulling the piston 33 to the right. This action causes hydraulic fluid to travel from the front of control cylinder 31 to the front of slave cylinder 32 via tubing 36. This forces the shaft 38 and piston 37 in slave cylinder 32 to move to the left. This drives hydraulic fluid from the back of slave cylinder 32 to the back of control cylinder 31 via tubing 35. The motion of slave shaft 38 is used in the positioning mechanism 2 to reposition the tip 16 of the instrument to the desired location.

FIG. 4c shows the reverse motion, in which the control shaft 34 is moved to the left, causing the slave shaft 38 to move to the right.

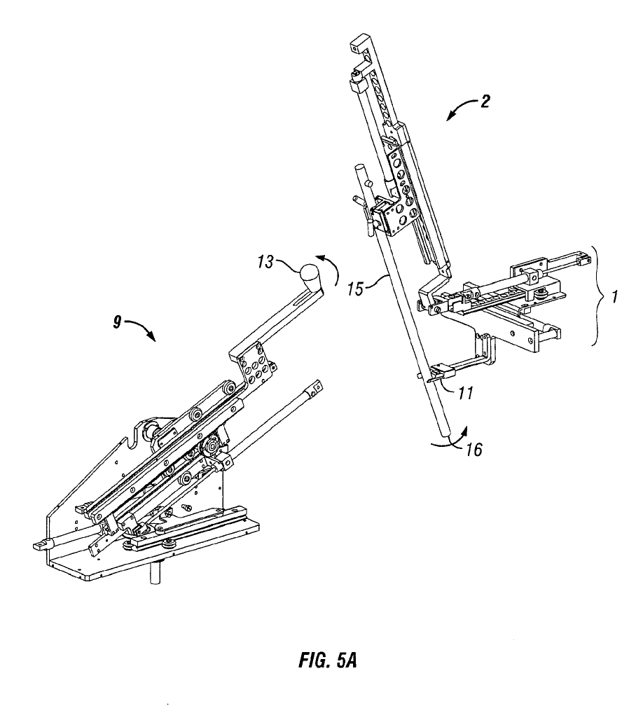

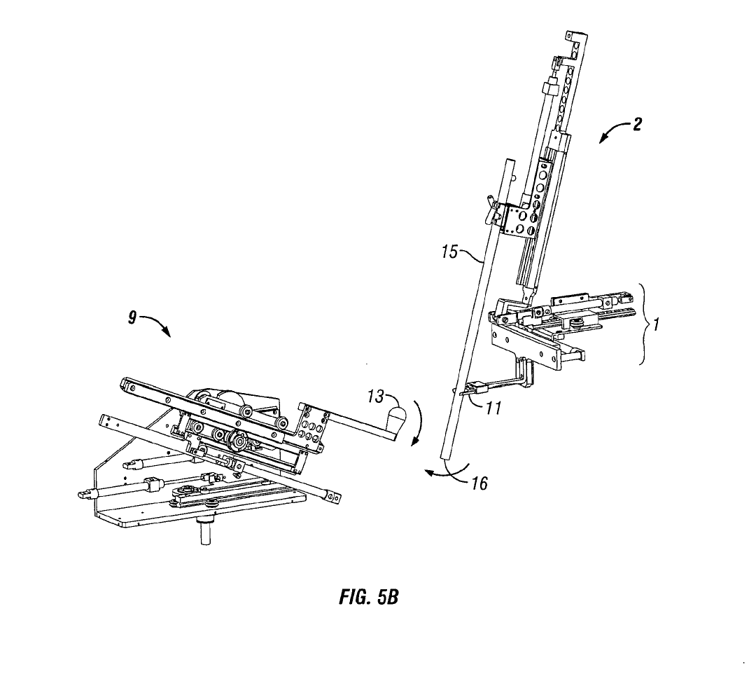

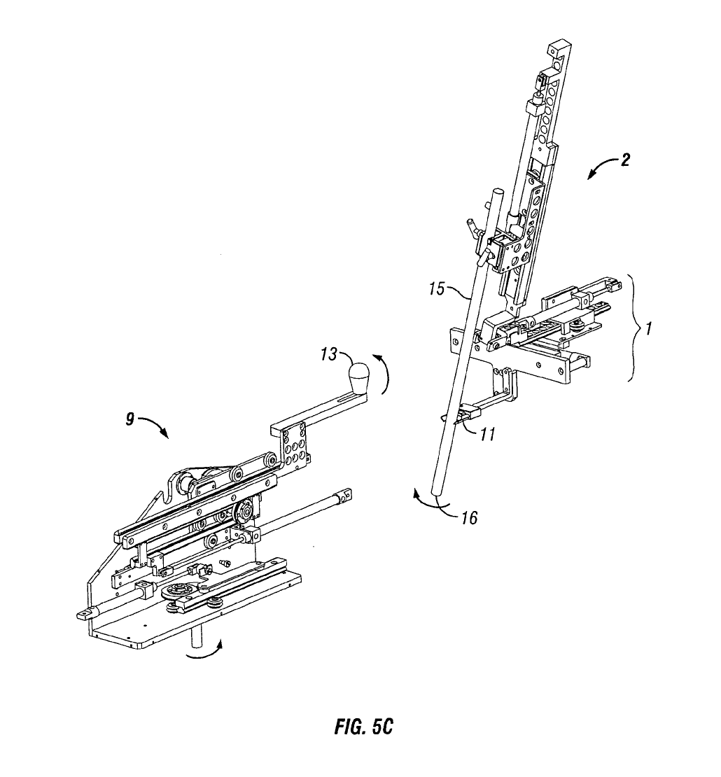

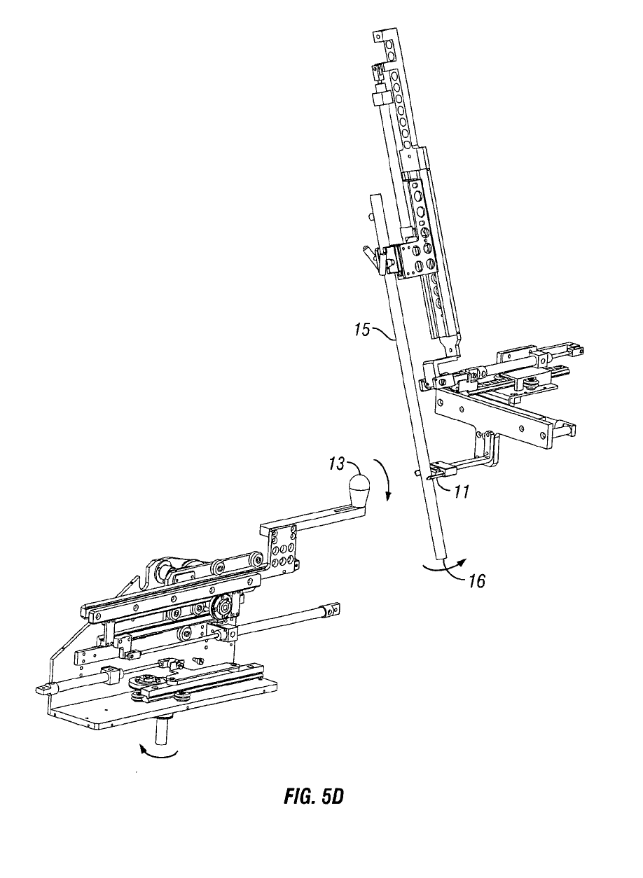

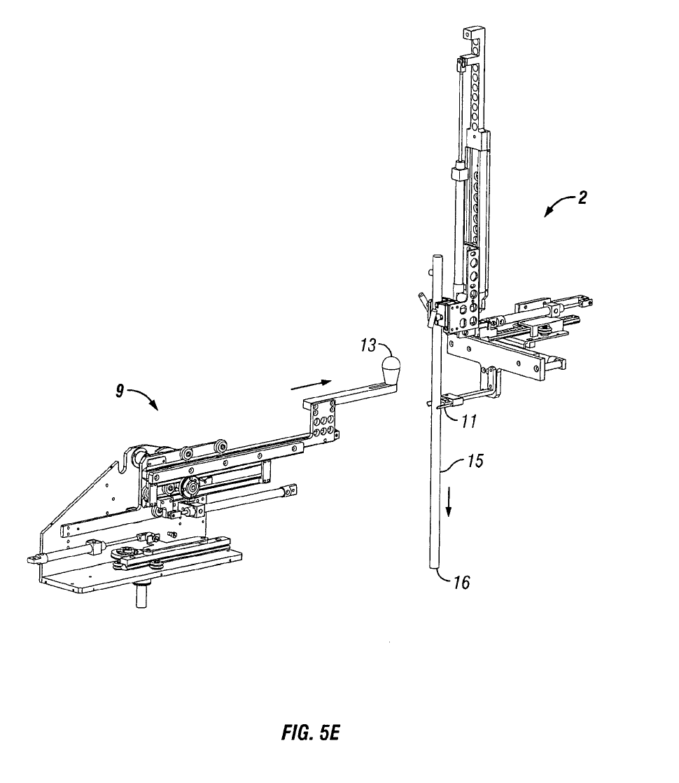

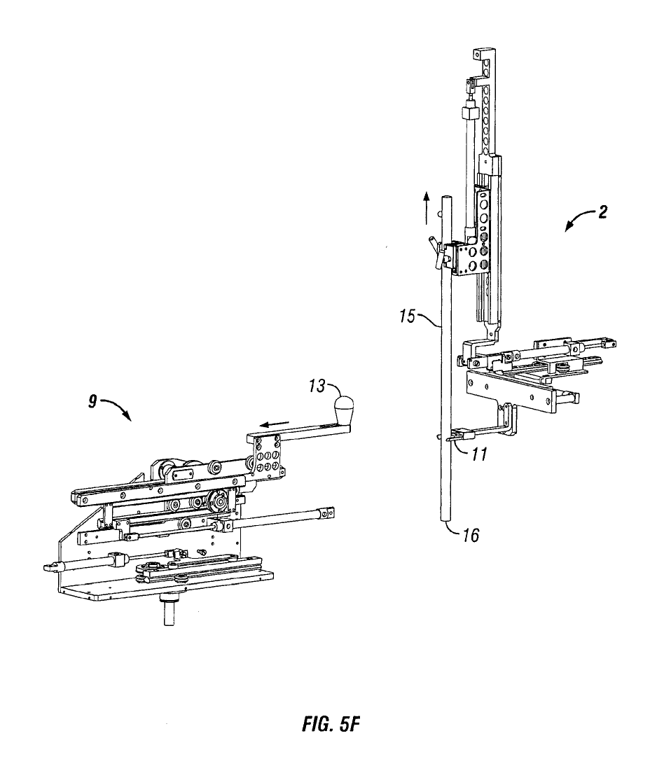

FIGS. 5a-f show the relationship between motions of the control handle 9 and an embodiment of the positioning mechanism 2. In FIG. 5a the knob 13 of control handle 9 has been pulled upward, forcing hydraulic fluid to travel between control cylinders in control handle 9 and slave cylinders in positioning mechanism 2, thereby causing positioning mechanism 2 to tilt the instrument 15 about point 11 and thus move the distal tip 16 of instrument 15 back in relation to the housing 1 of the positioning mechanism 2. FIG. 5b similarly shows the knob 13 pushed downward, causing tip 16 to move away from the housing 1 of positioning mechanism 2. FIG. 5c shows the knob 13 moved to the left, thereby driving tip 16 to the right relative to housing 1 of positioning mechanism 2. Similarly FIG. 5d shows the knob 13 moved to the right, thereby driving tip 16 to the left relative to housing 1 of positioning mechanism 2. In FIG. 5e the knob 13 is pushed forward to extend tip 16 further into the patient, and similarly FIG. 5f shows the knob pulled backward to retract tip 16 from the patient.

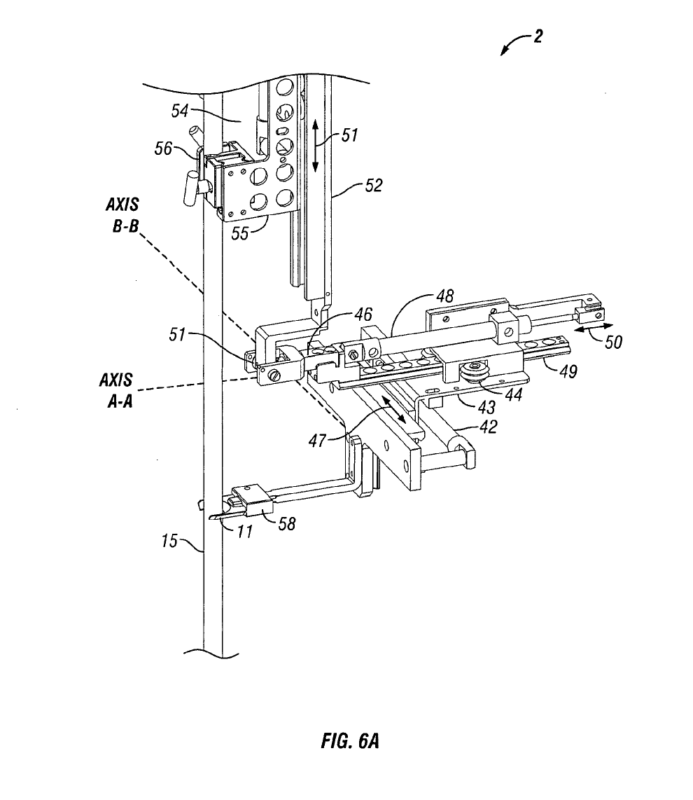

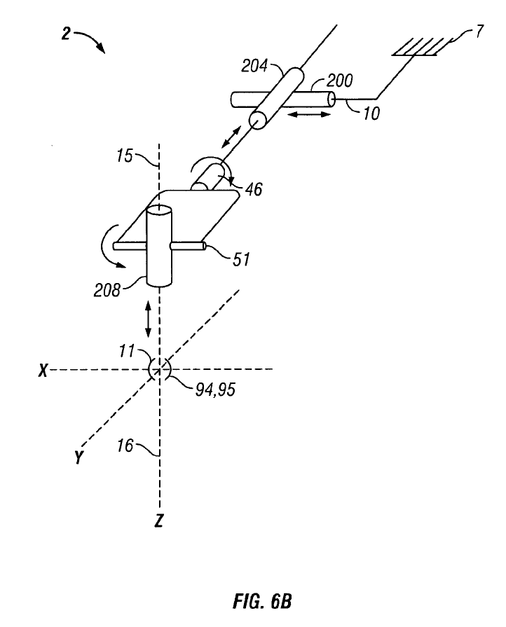

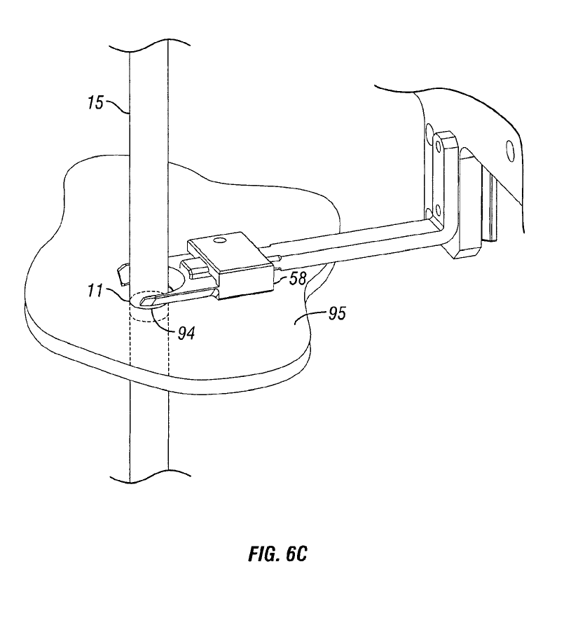

Referring to FIG. 6a, more detail of an embodiment of the positioning mechanism is provided. All three of the motion axes comprise a slave cylinder and guide device. The side-to-side motion is achieved by motion of slave cylinder 42, which pushes/pulls tilt slide assembly 44, which is free to move side-to-side as shown by arrow 47. This motion is transmitted to instrument slide assembly 52 by a non-rigid pivot bearing 46. This pivot bearing 46 allows the instrument slide assembly 52 to rotate about axis A-A and automatically assume the correct angle to permit the instrument 15 to pivot about point 11. The forward/backward motion is achieved by motion of slave cylinder 48, which pushes and pulls guide device 49 along rollers 44 as shown by arrow 50. The motion of guide device 49 is transmitted to instrument slide assembly 52 via non-rigid pivot bearing 51. This pivot bearing 51 allows the instrument slide assembly 52 to rotate about axis B-B and automatically assume the correct angle to permit the instrument 15 to pivot about point 11. The extend/retract motion is achieved by motion of slave cylinder 54, which pushes/pulls extend slide 55 in the direction indicated by arrow 57. Instrument 15 is attached to extend slide 55 by clamp 56, and thus extended or retracted in the patient.

FIG. 6b shows a schematic depiction that more clearly shows the movable elements of an embodiment of the positioning mechanism 2. In the depicted embodiment, the mechanism consists of a novel arrangement of three sliders, two rotating joints, and one spherical joint. A first slider 200 is mounted on adjustable arm 10, connected to support structure 7. A second slider 204 is mounted on first slider 200. A first rotating joint 46 is mounted on the second slider 204. A second rotating joint 51 is mounted on first rotating joint 46. A third slider 208 is mounted on second rotating joint 51. Spherical joint 210 is formed by the incision 94 in the patient's tissue 95 (as depicted in FIG. 6C). The transverse motion of first slider 200 is transmitted, via second slider 204 and first (46) and second (51) rotating joints, to third slider 208. This motion causes instrument 15 to pivot about incision 94, driving distal tip 16 in a direction opposite to the movement of the first slider. Similarly, transverse motion on second slider 204 is transmitted via first (46) and second (51) rotating joints to third slider 208. This motion causes instrument 15 to pivot about incision 94, driving distal tip 16 in a direction opposite to the movement of the second slider 204. Transverse motion of third slider 208 either extends the instrument 15 further into incision 94 or retracts the instrument further out of incision 94.

Because non-rigid pivot bearings 46 and 51 are free to move, a second pivot device is required at point 11 to force the instrument to pivot about this point. In a preferred embodiment the tissue of the patient acts as a pivot bearing, allowing instrument 15 to tilt about point 11. This embodiment is shown most clearly in FIG. 6C. In order to aid the user in locating the positioning mechanism 2 optimally over the incision 94 at point 11 in the patient tissue 95, a guide shoe 58 is provided. During setup the user locates the center of the shoe 58 over the incision 94 at point 11, then inserts the instrument 15 into the incision 94 in patient tissue 95, and attaches it to the extend slide 55 with clamp 56. Such a setup is depicted in FIG. 6A. In another embodiment a spherical bearing (not shown) is provided to create the second pivot bearing, which would be located over the incision at point 11 as well.

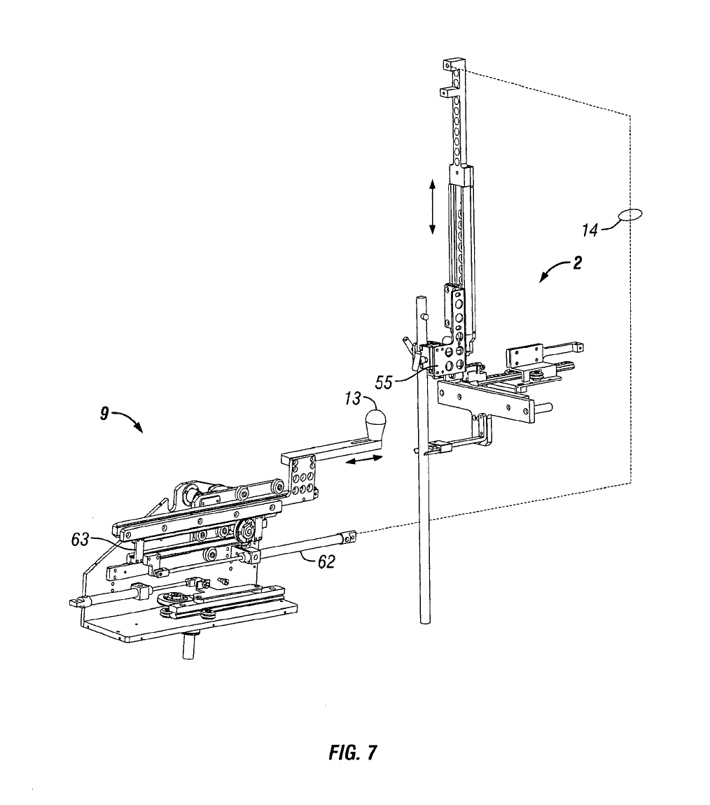

Referring to FIG. 7, an alternative embodiment is shown. In this embodiment, the mechanical force transmission connector 14 is a system of push-pull cable assemblies. Basic push-pull cable assemblies are well known in the art. Generally, push-pull cable assemblies comprise a flexible cable carried within a flexible guide tube. By pushing or pulling on one end of the cable, motion is transmitted to the other end of the cable, as is commonly seen in bicycle gear changing mechanisms. By example, in FIG. 7 the extend axis is shown driven by a push-pull cable assembly 62 which is attached to the extend mechanism 63 in control handle 9 and to the extend slide 55 in positioning mechanism 2. By pushing/pulling the knob 13 the cable in cable assembly 62 is pushed/pulled, causing the extend slide 55 in positioning mechanism 2 to move in response.

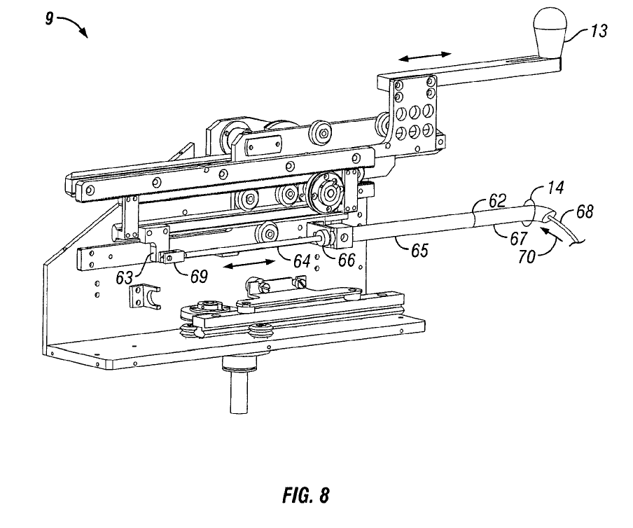

FIG. 8 shows more detail of the push-pull cable used in the extend axis of control handle 9. Push-pull assembly 62 comprises a rigid shaft 64 that is anchored to the extend mechanism 63 by coupling 69. As knob 13 is pushed-pulled, the extend mechanism 63 pushes or pulls on shaft 64 via coupling 69. Shaft 64 is pushed-pulled into housing 65. Within housing 65 the shaft 64 is connected to flexible cable 68, which slides within flexible guide 67. The resulting motion of cable 68 is indicated by arrow 70.

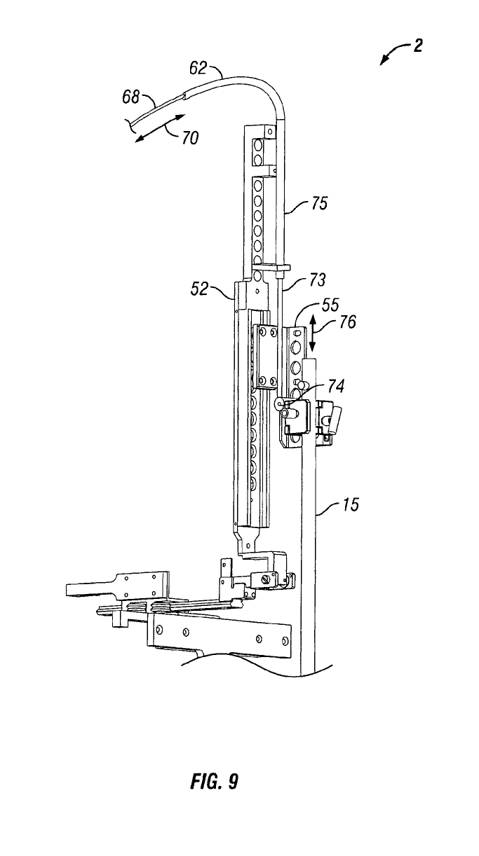

Referring now to FIG. 9, the cable assembly 62 terminates at the instrument slide assembly 52 of the positioning mechanism 2. The motion of the flexible cable 68, indicated by arrow 70, is transmitted to the extend slide 55 by rigid shaft 73. The resulting motion of extend slide 55 is indicated by arrow 76.

For clarity and simplicity FIGS. 7, 8, and 9 show only the extend axis driven by a push-pull cable assembly, but this invention contemplates that all motion axes described herein could be similarly be driven with push-pull cables.

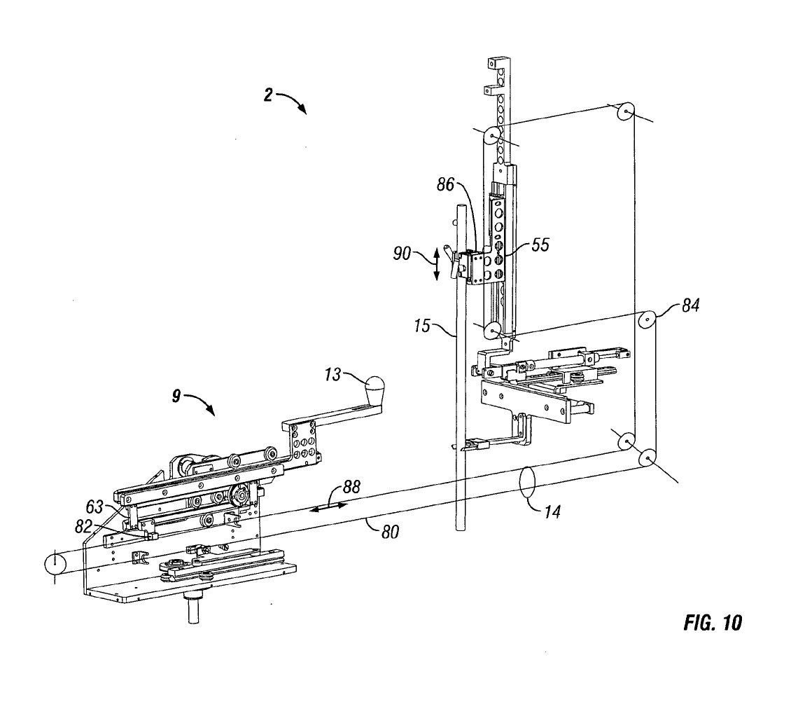

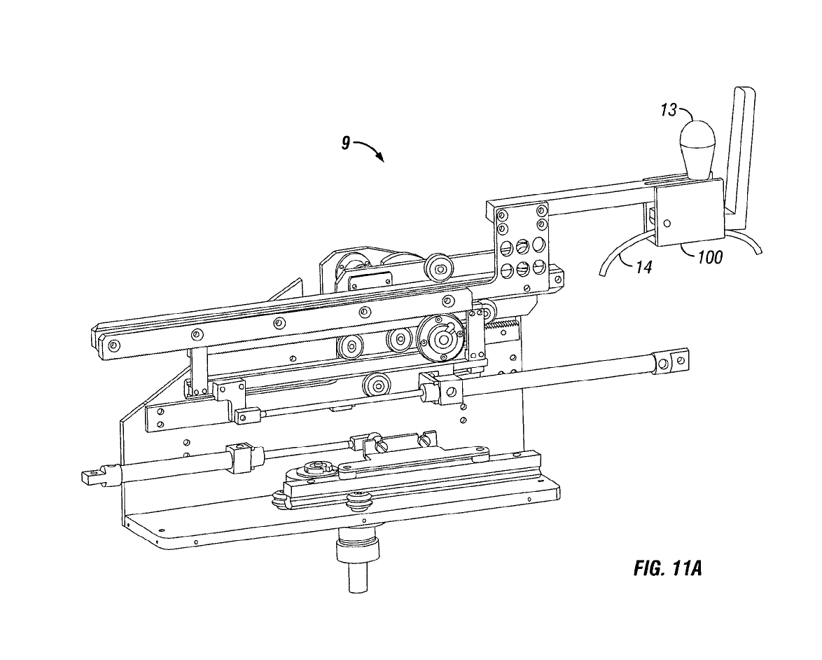

Another embodiment is shown in FIG. 10. In this embodiment the mechanical force transmission connector 14 is a system of cables and pulleys, shown in semi-schematic form. FIG. 10 depicts the extend axis driven by a cable/pulley arrangement. A flexible cable 80 is attached to the extend mechanism 63 on control handle 9 at coupling 82. Cable 80 is directed around several pulleys 84 to connect the extend mechanism 63 of the control handle 9 to the extend slide 55 on the positioning mechanism 2 at coupling 86. Motion of the extend mechanism 63 results in motion of the cable 80 as shown by arrow 88. This motion is transmitted to the extend slide 55 by cable 80, resulting in motion of the instrument 15 shown by arrow 90.

For clarity and simplicity FIG. 10 shows only the extend axis driven by a cable/pulley arrangement, but this invention contemplates that all motion axes described herein could be similarly driven with cable/pulley arrangements.

This invention also contemplates the use of other mechanical force transmission connections. For example, this invention includes devices utilizing rigid rods connected by universal joints and couplings, push-pull tapes, belts, chains, and ball drives.

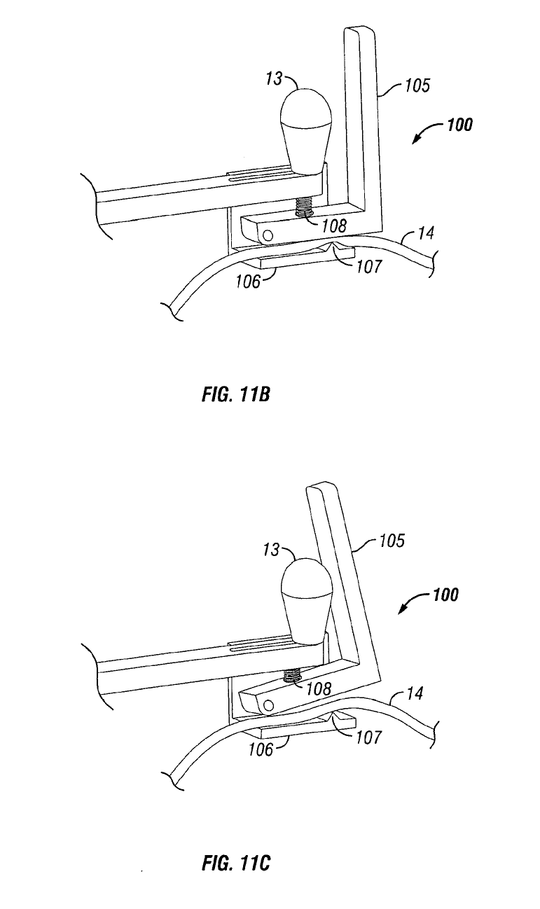

Other embodiments are illustrated in FIGS. 11a-b. Referring to FIG. 11a, a brake mechanism 100 is shown attached to the control handle 9. In the depicted embodiment, the brake 100 is normally on, i.e. the brake is active and preventing motion, unless deactivated by the user. To reposition the instrument, the user grasps the brake mechanism 100, applies force to deactivate the brake, and repositions the instrument. When the new position is reached the user releases the brake mechanism 100, thus reactivating the brake.

Referring to FIG. 11b, an embodiment of the brake mechanism 100 is shown, with one wall removed for clarity, in the actuated position. In this embodiment, the mechanical force transmission connector is hydraulic, but it is contemplated that a brake mechanism could be used with embodiments having any mechanical force transmission connector (for example, one utilizing push-pull cables or cable and pulley systems). In this embodiment, hydraulic tubing 14 (only one tube is shown for clarity) is pinched between pinch point 107 on brake housing 106 and brake lever 105 due to force applied by spring 108. Flow of hydraulic fluid through tubing 14 is thereby prevented, thus preventing motion of the instrument.

FIG. 11b shows an embodiment of the brake mechanism 100 in the deactivated position. Again, in this embodiment, the mechanical force transmission connector is hydraulic, but it is contemplated that a brake mechanism could be used with embodiments having any mechanical force transmission connector (for example, one utilizing push-pull cables or cable and pulley systems). The brake lever 105 has been pulled back toward knob 13, compressing spring 108 and causing brake lever 105 to rotate away from pinch point 107, thereby releasing pressure on, and allowing flow through, tubing 14. In this position motion is allowed and the instrument can be repositioned.

1. A device for use in positioning an instrument for use in a surgical procedure, comprising:
a mechanical positioning mechanism configured to couple to the instrument outside of a patient's body and to move the instrument relative to the patient's body;
a control mechanism; and
a connector operatively coupled to the control mechanism and the positioning mechanism, wherein the control mechanism is configured to cause the positioning mechanism to move the instrument by transmitting force applied by a human to the control mechanism through the connector.

2. The device of claim 1, herein the connector comprises a hydraulic system.

3. The device of claim 2, wherein the hydraulic system comprises a closed-loop hydraulic system.

4. The device of claim 1, wherein the connector comprises a push-pull cable system.

5. The device of claim 1, wherein the connector comprises a cable and pulley system.

6. The device of claim 1, wherein the connector includes more than one of a hydraulic system, a push-pull cable system, and a cable and pulley system.

7. The device of any one of claim 1, wherein the positioning mechanism is configured to utilize tissue of the patient to create a pivot point for positioning of the instrument within the patient's body.

8. The device of any one of claim 1, wherein the positioning mechanism comprises non-rigid pivot elements.

9. The device of any one of claim 1, wherein the positioning mechanism comprises a braking mechanism configured lock the instrument into a particular position, and wherein the control mechanism comprises an actuator for said braking mechanism.

10. A device for use in positioning instruments for use in a surgical procedure, comprising:
a means for positioning and/or holding an instrument;
a means for controlling said means for positioning and/or holding; and
a means for mechanically transferring force from the means for controlling to the means for positioning.

11. A device for use in positioning an instrument for use in a surgical procedure, comprising:
a positioning mechanism coupled to a support structure, wherein the positioning mechanism and support structure are located outside of a patient's body;
a surgical instrument coupled to the positioning mechanism and extending into the patient's body;
a control mechanism; and
a connector operatively coupled to the control mechanism and the positioning mechanism, wherein the control mechanism is configured to cause the positioning mechanism to move the instrument relative to the patient's body by transmitting mechanical or hydraulic control signals through the connector.

12. A method of positioning relative to a patient an instrument for use in a surgical procedure, the method comprising:
securing a positioning mechanism to a support structure, wherein the positioning mechanism and support structure are located outside of the patient's body;
inserting the instrument into the patient's body, wherein the instrument is coupled to the positioning mechanism; and
manipulating a control mechanism operatively coupled to the positioning mechanism, wherein manipulation of the control mechanism causes the positioning mechanism to move the instrument relative to the patient's body.

13. The method of claim 12, wherein the manipulation of the control mechanism causes the positioning mechanism to move the instrument by transmitting mechanical force from the control mechanism to the positioning mechanism.

14. The method of claim 13, wherein the mechanical force is transmitted using a push-pull cable system.

15. The method of claim 13, wherein the mechanical force is transmitted using a cable and pulley system.

16. The method of claim 12, wherein the manipulation of the control mechanism causes the positioning mechanism to move the instrument by transmitting hydraulic signals from the control mechanism to the positioning mechanism.

17. The method of claim 12, wherein the instrument is coupled to the positioning mechanism after insertion into the patient's body.

18. The method of claim 12, wherein the instrument is coupled to the positioning mechanism before insertion into the patient's body.

19. The method of claim 12, wherein manipulating the control mechanism comprises a human applying force to the control mechanism, wherein the force applied by the human is transmitted to the positioning mechanism.
